(19) United States
(12) Patent Application Publication
(10) Pub. No.: US 2007/0204062 A1
(43) Pub. Date: Aug. 30, 2007

(54) Active dynamic rule engine

(75) Inventors: W. James Gillis JR., Andover, MA (US); Aaron B. Flett, Merrimack, NH (US); Edwin Robbins JR., Sandown, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Aspect Software Company

(21) Appl. No.: 11/361,644

(22) Filed: Feb. 24, 2006

(51) Int. Cl. G06F 15/173

(52) U.S. Cl. 709/238; 709/242

(57) ABSTRACT

A system, method, and device for routing a request in a contact center are disclosed. The exemplary system may have a workstation for transmitting a request and a server responsive to said at least one workstation. The server may have a servlet container and filter portion for receiving and routing the request and for automatically generating a response to the request. The servlet container may create a response object when the request from the workstation is received, and associates the response objects with the response and the request. The filter portion may parse the request for one or more request objects to determine a routing destination and modify the response objects based on the routing destination.

### TECHNICAL FIELD

The present invention relates to a contact center and more particularly, to a device, method, and system for routing a request in a Web-based contact center.

### BACKGROUND INFORMATION

Contact centers place and receive telephone calls, emails, textual chats, and other methods of communication (hereinafter collectively referred to as “communications”) to customers. Agents at the contact center handle the communications with the customer and guide the customer in obtaining information or providing the requested information. Customers may include current customers, previous customers, and individuals with information or with a desire to obtain additional information.

A growing number of businesses have begun using contact centers to handle interactions between customers. Companies typically use contact center services, for example, to manage outbound and inbound communications campaigns to potential customers for telemarketing or to existing customers for collections information or customer follow-up. At any particular time a contact center may be handling multiple campaigns for multiple businesses.

Contact centers may have a first group of agents assigned to one campaign and a second group of agents assigned to a second campaign. Agents assigned to a campaign may have specific knowledge or skills necessary to respond to customers of the assigned campaign. For example, agents assigned to a first campaign may need to be proficient in a specific foreign language. All customers requesting an agent speaking the specific foreign language will be routed to the first campaign.

As previously discussed, contact centers may handle a variety of on-going campaigns. Communications received by the contact center may need to be routed to each specific campaign or agent. A server of the contact center may receive a variety of web-based communications using Hyper Text Transfer Protocol (HTTP). An application running on the processor of the server reviews the communication and determines the best campaign or agent to service the communication. The server then routes the communication to the respective agent. The continuous processing involved in stripping a communication and routing the communication may tax and slow the processing resources of the server. Accordingly, a need exists for a device, method, and system that routes communications while minimizing the processing resources of a contact center.

### SUMMARY

The present invention is a novel device, system, and method for routing a request in a contact center. An exemplary embodiment, according to the present invention, initiates a request from a workstation. The request is communicated from the workstation to a server. A response may be automatically generated for the request by the server. One or more response objects may be automatically produced with a servlet container of the server in response to the request. The response object may be associated with request objects of the request. The request may be automatically parsed for one or more request objects to determine a routing destination and modify the response objects based on the routing destination with a filter portion of the servlet container. Rules of the filter portion may determine the routing destination and may modify the response objects. The modified response object may be used to route the response to the previously determined destination.

In an alternative embodiment, the exemplary method for routing a request in a contact center may also communicate rule modifications from a filter maintenance module to the filter portion. The rules of the filter portion may be modified by the rules sent from the filter maintenance module. The modified rules then may be used to route the requests.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings herein:

FIG. 1 is a block diagram of a system for routing a request in a Web-based customer contact center according to the present invention.

FIG. 2 is a flow chart illustrating a first exemplary embodiment of a method for routing a request in a Web-based customer contact center according to the present invention.

FIG. 3 is a flow chart illustrating an example of the method for routing a request in a Web-based customer contact center according to the present invention.

FIG. 4 is a flow chart illustrating a second exemplary embodiment of a method for updating rules for routing a request in a Web-based customer contact center according to the present invention.

### DETAILED DESCRIPTION

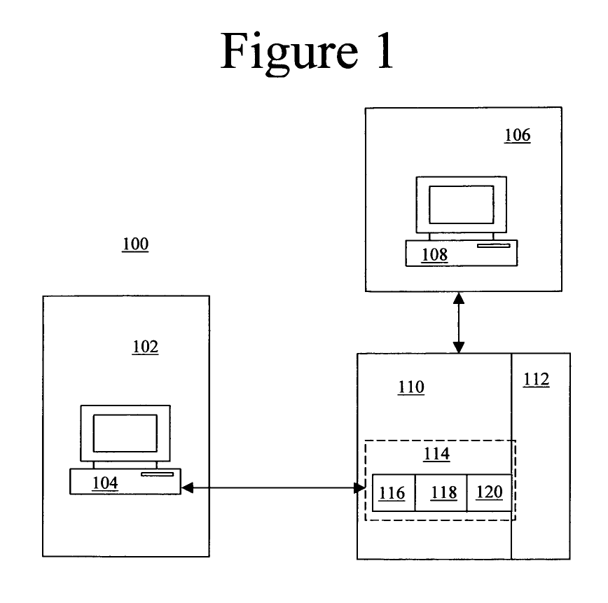

FIG. 1 is an exemplary system diagram of a system 100 used to provide routing in a Web-based HTTP protocol contact center. An agent 102 is an individual working at an agent workstation 104 within the contact center environment that interfaces with the customer. The customer 106 is represented generally as working at a customer workstation 108. The customer 106 and agent 102 communicate via a server 110. The agent workstation 104 may be a personal computer or other device for utilizing a Web browser to interface with customers 106, which in turn is in communication with a server 114 of the contact center. Similarly, the customer workstation 108 may also be a personal computer or other device for utilizing a Web browser to interface with the agent 102 via the server 110. The agent workstation 104 and customer workstation 108 may also include a telephone set or other communication devices for communicating with each other (not shown).

A customer 106 may at any time originate a request 112 to the server 114 to initiate a HyperText Markup Language (HTML) transaction with an agent of the contact center. The server determines the appropriate agent to handle the request and routes the request to the agent. The server 110 of the system 100 for routing HTML transactions in accordance with the present invention may include a servlet container 112. The servlet container 112 may have a minimum specification of a 2.3 Servlet Specification. The Tomcat 4.x server is an example of a server 110 having an acceptable specification servlet container 112. The Tomcat 4.x server is available through Apache Software Foundation. The servlet container 112 provides a runtime environment in which Web applications run, as well as the tools necessary to deploy the Web applications.

The server 112 also has at least one filter interface or portion 114. For illustration purposes the filter portion 114 of the system for routing 100, as shown in FIG. 1, is shown as a separate piece of equipment. However, the filter portion 114 may not be a separate piece of equipment. The filter portion 114 may be a part of the servlet container 112 as provided in the exemplary 2.3 Servlet specification. The filter may be a Java class that implements the filter interface and provides for pre- and post-processing of requests and responses.

In use, the customer makes the request to the server 110 via the customer workstation 108. The server 110 communicates the request to the servlet container 112. In tandem with receiving the request, the servlet container 112 of the server 110 may create request objects, a response and response objects. The request objects and response objects represent the HTML transaction between the customer and the agent. The request object contains all pertinent information about the request 20 and the response object contains information about the response 36. For example, but not limited to, the request objects and response objects may include the IP address, destination address, request path, request context, etc. of the customer. The servlet container 112 passes the request object to the filter portion 114 and then to the agent's workstation 104 as part of the response. It is important to note that neither the request objects nor response objects are sent to the customer. Below is a table of an example request and response for a potential catalog customer.

| | |
|---|---|
| Request | Response |

| | | | |
|---|---|---|---|
| Name | Aaron Buyer | Name | Aaron Buyer |
| Language | Spanish | Language | Spanish |
| Reference ID | 1051005 | Reference ID | 1051005 |
| Agent | Undefined | Agent | Joe Agent |
| Initiated | customer | Initiated | customer |

The request objects associated with the above request include “Aaron Buyer”, “Spanish”, “105100”, “Undefined” and “customer”. The request objects are the values that are added to the HTTP request. Similarly, the response objects associated with the above response include “Aaron Buyer”, “Spanish”, “105100”, “Joe Agent” and “customer”.

The response objects are the values that are added to the HTTP response. The request objects and response objects are not limited to the above example. The request objects and response objects may be a variety of values.

The transactions come in from the customer via a client application, for example, a web browser that is communicating using the HTTP protocol. The request is placed into the server 110 or servlet container 112, which in turn has a filter portion 114 set up to preprocess the request. The filter portion 114 is set to identify the predefined request objects. The filter portion 114 examines the request to determine if a request object is associated with a specific agent or group of agents. If a request object is associated with a designated agent or group of agents, the response to the request is routed to the designated agent based on the request object via a servlet running in the servlet container 112. The servlet can deliver and distribute the response in a variety of manners. For example, an application on the agent's workstation 104 may poll the servlet 112. In another example the servlet 112 may place the response in a queue, which is then interrogated by an application on the agent's workstation or a group of agent workstations designated by request.

The agent's communication to the customer may also be routed by the server 14 or servlet container 112 in the reverse fashion. The request sent by the agent is sent to the server 110 or servlet container 112 by the agent's workstation. The servlet container 112 runs the request through the filter portion 114. The filter portion 114 is set to identify the request object, as previously discussed. If the request is associated with a designated customer, the request is routed to the customer via a servlet running in the servlet container 114.

In addition to modifying responses, the servlet container 112 may create unique tokens for both the requests and the responses. The unique token is a string identifier that is used to keep HTML transactions separate from each other. The unique token may also be the presence of a string. In the above example request and response, the unique token may be any of the request objects or response objects. For example, if transactions with customers are intended to be routed to any agent, the unique token may be the presence of a customer name string. The presence of the string “Aaron Buyer” or any string in the customer name request object may trigger the routing of the request. In another example the routing token may be a specific string. For example, “Joe Frontline” in the agent string would provide routing of requests to agent “Joe Frontline”. The unique token may be selected based on the desired application or protocol.

The filter portion 18 may include a plurality of filters that are operatively connected in series or in a chain. In FIG. 1 the exemplary embodiment shown has three filters 116, 118, and 120; however, the number of filters is not limited to three. The number of filters may depend upon the desired function as explained below. In the exemplary embodiment, the system 100 has a first filter 116, a second filter 118, and a third filter 120. The first filter 116 may identify requests with a language of English. The first filter 116 may route requests with a language of English to a queue associated with a group of agents fluent in English. The second filter 118 may identify requests with a language of Spanish. The second filter 118 may route requests with a language of Spanish to a queue associated with a group of agents fluent in Spanish. The third filter 120 may identify requests with a language other than English or Spanish. The third filter 120 may send a response to the customer asking the customer to select a time and date for an agent to contact them. It is important to note that each filter may perform a different function. In alternative embodiments, additional filters may be added to perform additional functions.

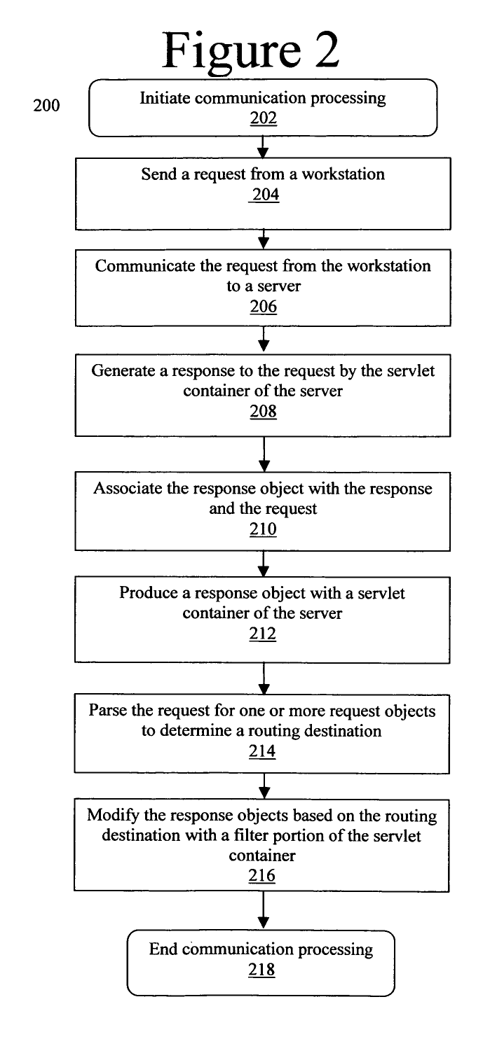

A first exemplary method of the invention, shown in FIG. 2, provides a method of routing a request in a Web-based HTTP protocol contact center. The server initiates the communication process (block 202). The workstation of the customer creates a request (block 204). The request may be from a Web-based form or an application running on the customer's workstation. The workstation of the customer transmits the request to the server of the contact center (block 206). The servlet container generates a response to the request (block 208). The servlet container associates the request objects with the received request (block 210). Response objects are produced based on the request objects (block 212). The filters parse the request for one or more request objects to determine a routing destination based on the predefined rules of the filters (block 214). The response objects may be modified based on the implemented rules of the filter portion of the servlet container (block 216). The servlet can deliver and distribute the response in a variety of manners, as previously discussed. The processing of the communication is completed (block 218).

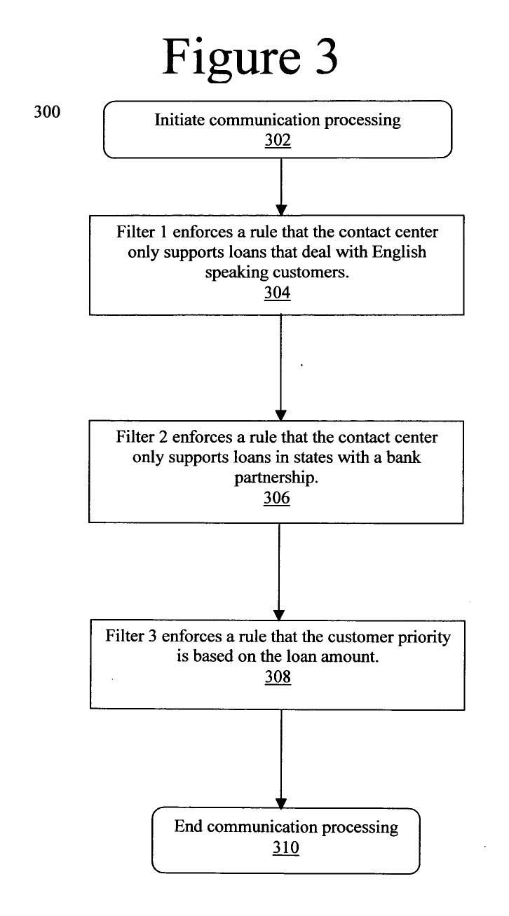

FIG. 3 is a flow chart illustrating an example of the method for routing a request in a Web-based customer contact center, according to the present invention. The method 300 illustrates the use of rules within filters to route a customer within a contact center that is administrating a campaign associated with personal loans. The customer submits a request for approval for a loan to the contact center via a Web browser. The customer completes a form within the Web browser. A request is produced with request objects based on the entries of the form provided by the customer. The request is transmitted to the server. The communication processing is initiated and the servlet generates a response based on the request and applies the filter rules (block 302).

The first filter enforces a rule related to the contact center only supporting loans that deal with English speaking customers (block 304). The filter takes the HTTP request and strips out the language value. If the value is English then the request is passed on to the next filter. However, if the value is Spanish, a response object may be inserted in the response with an identification number associated with the customer contact center or campaign. The response may redirect the customer to another contact center or campaign that is partnered with the original contact center or campaign. The other contact center or campaign may deal exclusively with loans for Spanish speaking customers. The identification number associated with the original contact center will allow the new contact center to allocate proper corresponding referral credits to the original contact center. If the language value is not English or Spanish the response may redirect the customer to another page that informs them that the contact center is unable to do business with them for the reasons provided on the Web page.

Filter 2 enforces a rule related to the contact center only supporting loans in states where the campaign has a partnership with a bank operating in those states (block 306). This filter takes the HTTP request and strips out the state value. It checks to see if it is a supported state. If it is, then the filter passes the request on to the next filter. If the request is not from a supported state, then the HTTP response is set to redirect the customer to another Web page that informs the customer that the campaign does not accept loans from the location requested.

Filter 3 enforces a rule relating to the customer priority being based on the loan amount (block 308). This filter takes the loan amount value from the request and then sets a value of a response object of the response to a corresponding predefined URL based on the loan amount. This redirect location may be a Web page with agents waiting to chat via the browser with the customer, or a Web page that contains a phone number to an agent or connects the customer via IP telephony to an agent. Customers with various loan amounts may be connected to various groups of agents based on the customer's loan amount. The communication processing is completed (block 310). The method and system allow the server to route customers that are English speaking and applying for a loan in a supported state to an agent or group of agents that can quickly and properly address the customer's specific needs.

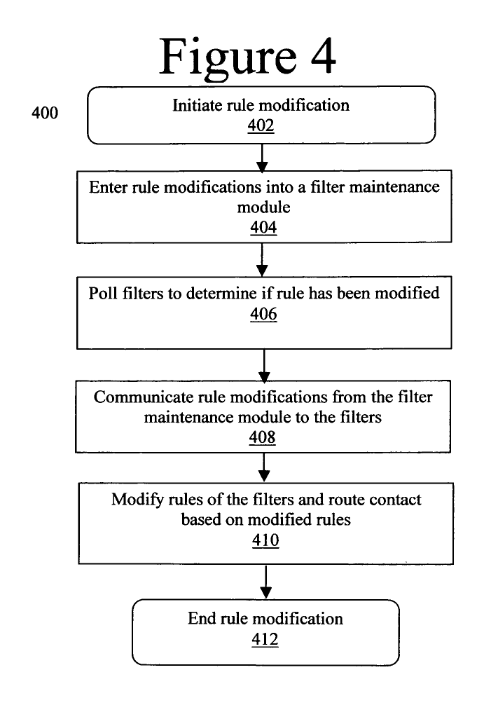

The second exemplary embodiment 400, shown in the flow chart illustrated in FIG. 4, provides a method for modifying the rules of the filters. The rule modification may be initiated by an administrator or periodically updated by a filter maintenance module (block 402). The filter rules may need to be updated when campaigns of the contact center end or are initiated. The filter rules may also need to be updated due to changes in the campaign. For example, a campaign may require a variety of options or agents initially and then taper-off as the campaign nears completion. An administrator enters the rule modifications into the filter maintenance module (block 404). The filter maintenance module may poll the filters to determine whether the rules entered into the filter maintenance module are different and more recent than the rules currently in the filter (block 406). If the rules are different and more recent, the rules are communicated from the filter maintenance module to the filters (block 408). The filter maintenance module may also be programmed to automatically change or substitute rules in the filter based on predefined scheduled changes. After the rules are modified the communications are routed based on the updated rules of the filters (block 410). The rule modification is complete and waits for the next scheduled or requested updates (block 412).

The exemplary embodiments described herein may be associated with the processor and memory associated with the server of the contact center or a host computer for each campaign. In addition, the aspects described in the exemplary embodiments may also be implemented in a variety of digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, a communications processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is not intended to be limited to a system, device, or method which must satisfy one or more of any stated or implied object or feature of the invention and is not limited to the exemplary embodiments described herein. Modifications and substitutions by one of ordinary skill in the art are considered to be within the scope of the present invention.

The invention claimed is:

1. A system for routing a request in a contact center, the system comprising:
at least one workstation for transmitting a request;
a server, responsive to said at least one workstation, and having a servlet container and filter portion, for receiving and routing the request and for automatically generating a response to the request;
wherein the servlet container creates a response object when the request from the workstation is received, and for associating the response objects with the response and the request;
wherein the filter portion parses the request for one or more request objects to determine a routing destination and modifies the response objects based on the routing destination.

2. The system of claim 1, wherein the filter portion parses the request for one or more request objects to determine a routing destination and modifies the response by inserting a unique token based on the routing destination.

3. The system of claim 1, wherein the request is a hypertext transfer protocol.

4. The system of claim 1, wherein the filter portion is a chain of two or more filters.

5. The system of claim 2, wherein the unique token is a unique string identifier.

6. The system of claim 1, further comprising:
a filter maintenance module external to the filter portion for modifying rules of the filter portion used to determine the routing destination and modify the response objects based on the routing destination.

7. The system of claim 6, wherein the filter maintenance module notifies the filter of modifications and the filter portion initiates updating of the rules.

8. A method for routing a request in a contact center, the method comprising the acts of:
initiating a request from a workstation;
communicating the request from the workstation to a server;
responsive to said communicating act, automatically generating a response to the request by the server to the workstation;
responsive to said initiating and generating acts, automatically producing a response object with a servlet container of the server, and associating the response object with the response and the request;
responsive to said generating act, automatically parsing the request for one or more request objects to determine a routing destination and modify the response objects based on the routing destination with a filter portion of the servlet container.

9. The method of claim 8, wherein the act of parsing the request for one or more request objects modifies the response by inserting a unique token based on the routing destination.

10. The method of claim 8, wherein the request is a hypertext transfer protocol.

11. The method of claim 8, wherein the filter portion is a chain of two or more filters.

12. The method of claim 9, wherein the unique token is a unique string identifier.

13. The method of claim 8, further comprising:
communicating rule modifications from a filter maintenance module to the filter portion; and
modifying rules of the filter portion used to determine the routing destination and modify the response objects based on the communicated rule modifications.

14. The method of claim 8, further comprising:
notifying the filter of modifications by the filter maintenance module; and
initiating updating of the rules of the filter portion by the filter portion.

15. A computer program product, tangibly embodied in an information carrier, for routing a request in a contact center, the computer program product being operable to cause a machine to:
receive a request from a workstation to a server;
responsive to said receiving the request, automatically generate a response to the request by the server to the workstation;
responsive to said generating a response, automatically produce a response object with a servlet container of the server, and associate the response object with the response and the request; and
responsive to said generating a response, automatically parse the request for one or more request objects to determine a routing destination and modify the response objects based on the routing destination with a filter portion of the servlet container.

16. The computer program product of claim 15, wherein the act of parsing the request for one or more request objects further comprising the computer program product being operable to cause a machine to modify the response by inserting a unique token based on the routing destination.

17. The computer program product of claim 15, wherein the request is a hypertext transfer protocol.

18. The computer program product of claim 15, wherein the filter portion is a chain of two or more filters.

19. The computer program product of claim 16, wherein the unique token is a unique string identifier.

20. The computer program product of claim 15, further comprising the computer program product being operable to cause a machine to:
communicate rule modifications from a filter maintenance module to the filter portion; and
modify rules of the filter portion used to determine the routing destination and modify the response objects based on the communicated rule modifications.
